(19) United States
(12) Patent Application Publication
(10) Pub. No.: US 2025/0377683 A1
(43) Pub. Date: Dec. 11, 2025

(54) UNIVERSAL KNOB ASSEMBLY

(71) Applicant: Carl Demardrian Virgil, Las Vegas, NV (US)

(72) Inventor: Carl Demardrian Virgil, Las Vegas, NV (US)

(21) Appl. No.: 19/229,317

(22) Filed: Jun. 5, 2025

Related U.S. Application Data
(60) Provisional application No. 63/656,337, filed on Jun. 5, 2024.

(51) Int. Cl. G05G 1/10

(52) U.S. Cl. CPC G05G 1/10

(57) ABSTRACT

A universal knob assembly system is disclosed. The universal knob assembly system has a knob portion with an interior post, wherein the knob portion is adapted so that one of a plurality of removable stem receivers can be connected thereto. Each stem receiver has a nearly identical input end and a different output end relative to the other stem receivers. The input end may slidably interface with the interior post by way of complementary vertical ribbing. The output end has a stem slot configured to receive a knob stem of an appliance. Because each stem slot is differently sized and dimensioned relative to the other stem slots of the plurality of removable stem receivers, the subject disclosure enables a universal knob assembly system. The universal knob assembly system can be operatively associated with different types of intrinsic knob stems based on the selected stem receiver.

### CROSS REFERENCE TO RELATED APPLICATION

This application claims the benefit of priority of U.S. provisional application No. 63/656,337, filed Jun. 5, 2024, the contents of which are herein incorporated by reference.

### BACKGROUND OF THE SUBJECT DISCLOSURE

The present subject disclosure relates to knob assemblies and, more particularly, to a universal knob attachment adapted to be selectively operatively associated with different sized specialty ranges, grills, ovens, or other appliances

There are many different appliances used for cooking, such as grills, ranges, ovens and that like, that use knobs to control the heating element or possibly other functionality of the appliance. The knob is frequently removably attachable to the appliance by way of a knob stem intrinsic to the application. There is also a myriad of different brands and models for each of these appliances, resulting in a plethora of differently sized appliance knob stems.

As a result, if that original manufacturer knob is lost or rendered inoperable, it can be very difficult to replace. Furthermore, for manufacturers of original as well as replacement knobs, there is an increased cost and tooling to make many different knobs assemblies (each having a different size interface to operatively associated with the different sized intrinsic knob stems) as opposed to making the same kind of knob assembly over and over that can be used with different sized intrinsic knob stems.

As can be seen, there is a need for a universal knob assembly configurable to operatively associate with different specialty ranges, grills, ovens and other appliances and applications, whereby one knob can be used with all appliances demanding a specialty knob.

### SUMMARY OF THE SUBJECT DISCLOSURE

In one aspect of the present subject disclosure, a universal knob assembly system for different intrinsic knob stems includes the following: a knob portion having an interior post; a plurality of removable stem receivers, each removable stem receiver having an input end and an output end, wherein the input end is configured to operatively associated with the interior post, and wherein the output end has a stem slot configured to receive an intrinsic knob stem of an appliance; and each stem slot is differently sized and dimensioned relative to the other stem slots of the plurality of stem slots, whereby the plurality of knob stem receivers is configured to operatively associate with the different intrinsic knob stems.

In another aspect of the present subject disclosure, the universal knob assembly system further includes wherein each removable stem receiver has circumferential vertical ribbing, and wherein the interior post defines a post slot having inner vertical ribbing complementary with the circumferential vertical ribbing, wherein the circumferential vertical ribbing extends from the input end to the output end, wherein each removable stem receiver is slidably engageable with the post slot by way of said vertical ribbings between an associated condition and a disassociated condition, wherein each removable stem receiver has one or more fastener holes; and further including one or more fasteners for forming a locked engagement between an operatively associated intrinsic knob stem and a selected removable stem receiver of the plurality of removable stem receiver.

In yet another aspect of the present subject disclosure, a method for adapting a plurality of intrinsic knob stems, wherein each intrinsic knob stem has a different size relative to remaining intrinsic knob stems of the plurality of knob stems, includes the following steps: for each intrinsic knob stem, forming a locked engagement between a different removable stem receiver of the plurality of stem receivers of a universal knob assembly system disclosed above; and operatively associating the knob portion to a respective input end of said universal knob assembly system to control a rotation of a desired intrinsic knob stem.

These and other features, aspects and advantages of the present subject disclosure will become better understood with reference to the following drawings, description and claims.

### BRIEF DESCRIPTION OF THE DRAWINGS

FIG. 1 is a top perspective view of an exemplary embodiment of the subject disclosure, shown in a used condition engaging an intrinsic knob stem 28 of an appliance.

FIG. 2 is a bottom perspective view of an exemplary embodiment of the subject disclosure, illustrating the removable stem slot 24 that operatively associates with the intrinsic knob stem 28.

FIG. 3 is an exploded bottom perspective view of an exemplary embodiment of the subject disclosure.

FIG. 4 is a detailed perspective view taken along line 4-4 in FIG. 3, illustrating the complementary vertical ribbing 15 and 17 of the interior post slot 16 and the removably stem receiver 18, respectively.

FIG. 5 is an exploded top perspective view of an exemplary embodiment of the subject disclosure, shown in the used condition with the removably stem receiver 18 in a disassociated condition relative to the intrinsic stem 28.

FIG. 6 is a section view taken along line 6-6 in FIG. 1, illustrating how the fasteners 20 fixedly (though removably) attach the intrinsic stem 28 to the stem receiver 18. Note that this attachment can be done with the knob portion 12 removed from the removably stem receiver 18.

FIG. 7 is a top plan view of an exemplary embodiment of the subject disclosure, illustrating installation wherein the insert attaches over and secures to the control stem by way of two fasteners 20; depending on application a third screw may be used.

FIG. 8 is a top plan view of an exemplary embodiment of the subject disclosure, illustrating implementation wherein the knob fits over the insert in any orientation needed.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, a universal knob assembly system is disclosed. The universal knob assembly system has a knob portion with an interior post, wherein the knob portion is adapted so that one of a plurality of removable stem receivers can be connected thereto. Each stem receiver has a nearly identical input end and a different output end relative to the other stem receivers of the plurality of removable stem receivers. The input end may slidably interface with the interior post by way of complementary vertical ribbing. The output end has a stem slot configured to receive a knob stem of an appliance. Because each stem slot is differently sized and dimensioned relative to the other stem slots of the plurality of removable stem receivers, the subject disclosure enables a universal knob assembly system. The universal knob assembly system can be operatively associated with different types of intrinsic knob stems based on the selected stem receiver.

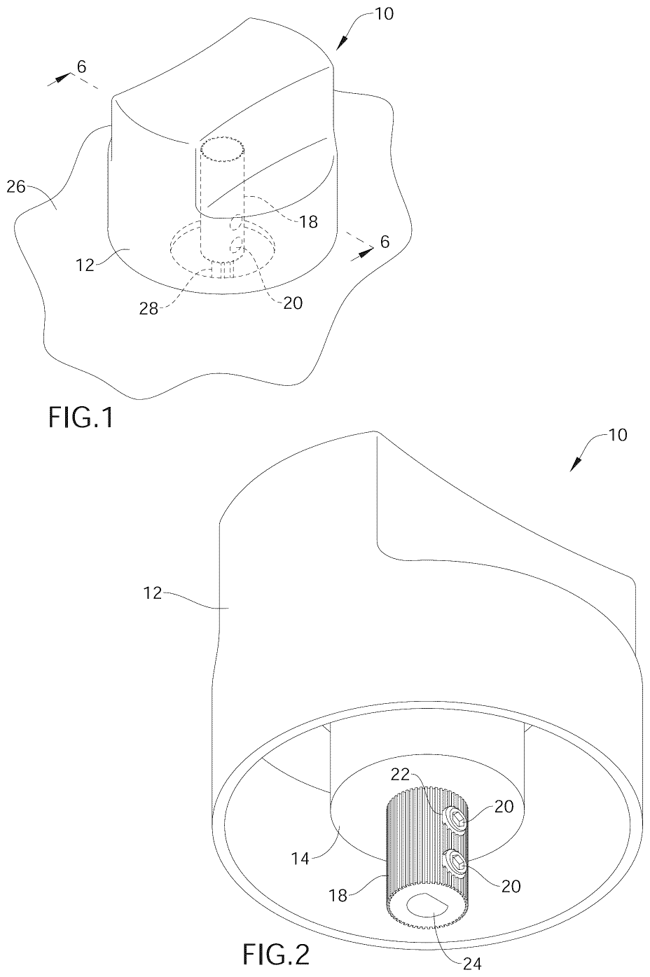

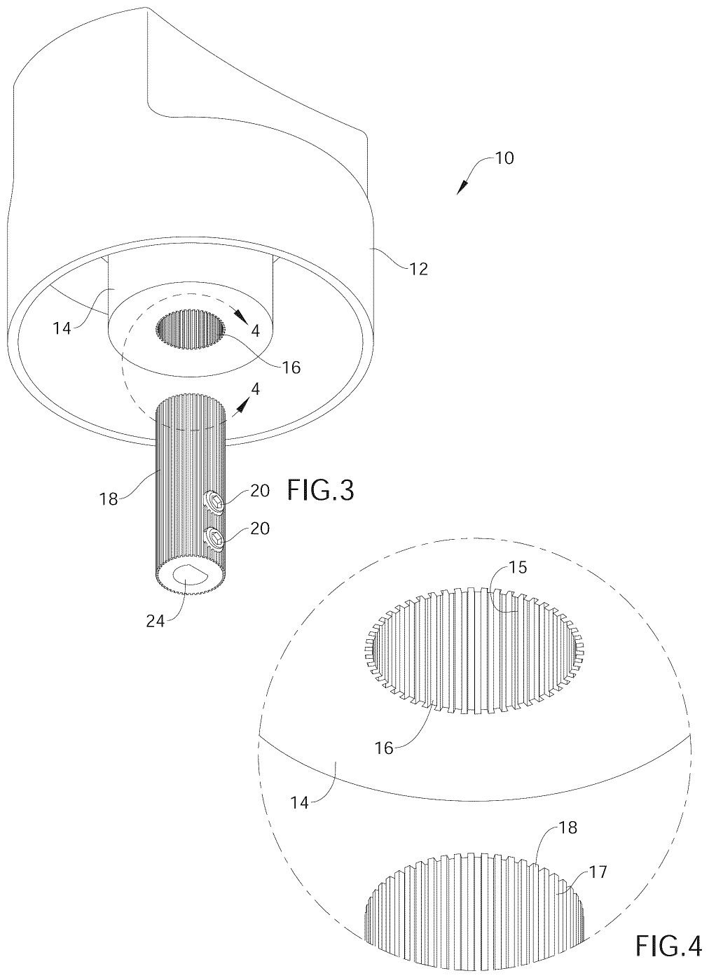

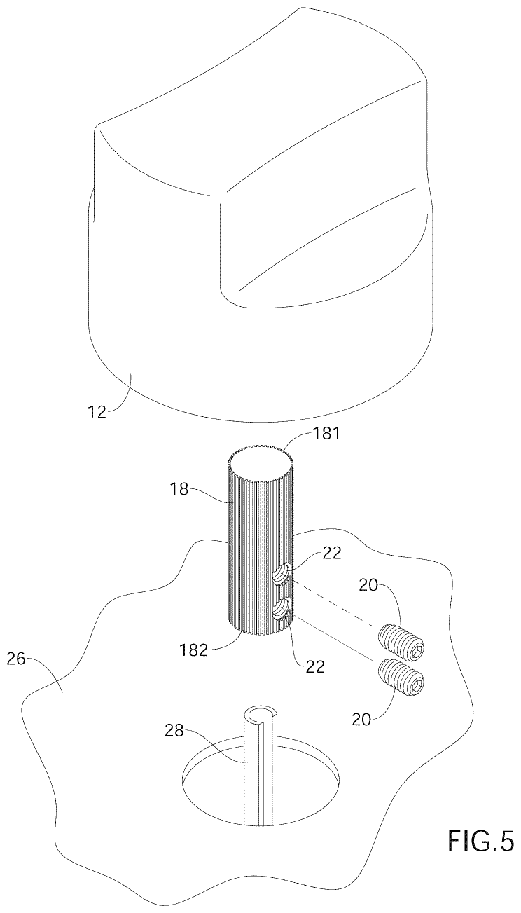

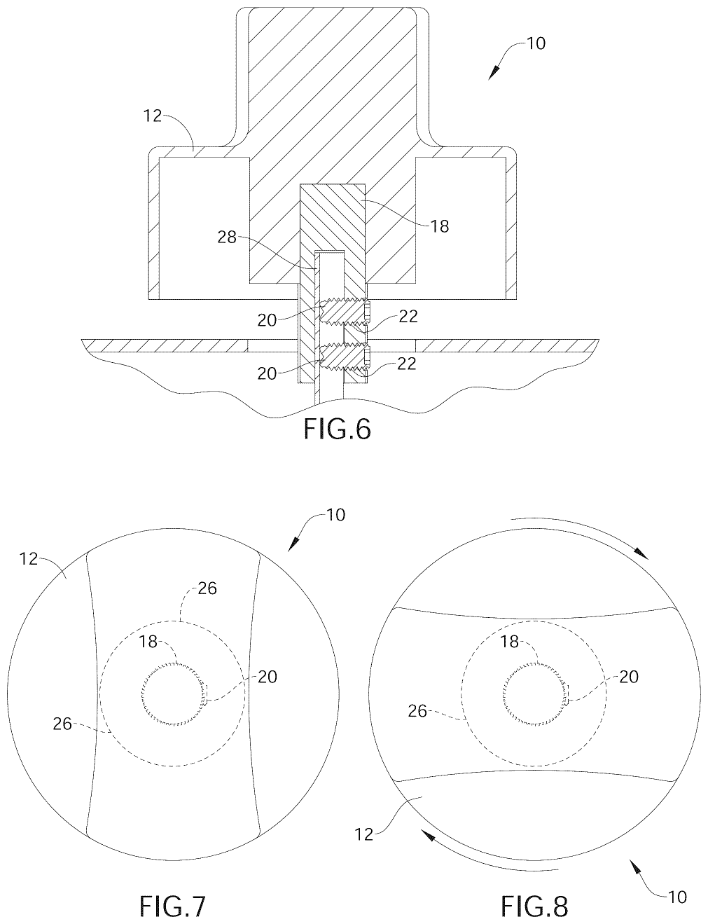

Referring to FIGS. 1 though 8, the subject disclosure includes a universal knob assembly 10 having a knob portion 12 and an interior post 14. The interior post 14 defines a post slot 16 dimensioned and shaped to slidably engage with a removable stem receiver 18 by way of complementary ribbing 15 and 17, respectively. The subject disclosure contemplates having a plurality of removable stem receivers 18, each having an input end 181 for slidably engaging with the post slot and an output end 182 for operatively associating with an intrinsic knob stem 28 of an appliance 26.

Each removable stem receiver 18 defines a stem slot 24 at its output end 182. The stem slot 24 is dimensioned and shaped to move between an associated condition and a disassociated condition relative to the intrinsic knob stem 28. In the disassociated condition the removable stem receiver 18 is disconnect from the intrinsic knob stem 28, while in the associated condition the intrinsic knob stem 28 is received in the stem slot 24.

In the associated condition, the knob stem 28 can be fixedly retained within the stem slot 24 by way of one or more fasteners 20 (including but not limited to set screws), forming a removably fixed engagement. The one or more fasteners 20 find purchase through the side of the removable stem receiver 18 via fastener holes 22 therein.

With a plurality of different removable stems 18, each with the same input end 181 that operatively associates with the post slot 16 but each with different sized stem slot 24 to snugly and slidably received differently sized knob stems 28, a universal knob assembly system is enabled through a user selecting a stem receiver 18 that sufficiently receives a given intrinsic knob stem 28 so as to form the fixed engagement thereto. Conceptually, the removable stem receiver 18 is an adapter that converts the interfacing portion of the intrinsic knob stem 28 of any appliance into an adapted interfacing portion that works with any removable knob portion 12. Thus, once all desired intrinsic knob stems 28 are so adapted, any misplaced or damaged, the knob portion 12 can be replaced with another possibly identical knob portion 12 of the system embodied in the subject disclosure. The knob assembly 10 may be made from any type of material—including metallic and plasticized material sufficient to enable the disclosure herein. This combination of repeatable size and material of knob portion makes their manufacturer and tooling costs lower than the prior art.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A universal knob assembly system for different intrinsic knob stems, the universal knob assembly system comprising:
a knob portion having an interior post;
a plurality of removable stem receivers, each removable stem receiver having an input end and an output end, wherein the input end is configured to operatively associated with the interior post, and wherein the output end has a stem slot configured to receive an intrinsic knob stem of an appliance; and
each stem slot is differently sized and dimensioned relative to the other stem slots of the plurality of stem slots, whereby the plurality of knob stem receivers is configured to operatively associate with the different intrinsic knob stems.

2. The universal knob assembly system of claim 1, wherein each removable stem receiver has circumferential vertical ribbing, and wherein the interior post defines a post slot having inner vertical ribbing complementary with the circumferential vertical ribbing.

3. The universal knob assembly system of claim 2, wherein the circumferential vertical ribbing extends from the input end to the output end.

4. The universal knob assembly system of claim 2, wherein each removable stem receiver is slidably engageable with the post slot by way of said vertical ribbings between an associated condition and a disassociated condition.

5. The universal knob assembly system of claim 2, wherein each removable stem receiver has one or more fastener holes.

6. The universal knob assembly system of claim 5, further comprising one or more fasteners for forming a locked engagement between an operatively associated intrinsic knob stem and a selected removable stem receiver of the plurality of removable stem receiver.

7. A method of adapting a plurality of intrinsic knob stems, wherein each intrinsic knob stem has a different size relative to remaining intrinsic knob stems of the plurality of knob stems, the method comprising:
for each intrinsic knob stem, forming a locked engagement between a different removable stem receiver of the plurality of stem receivers of a universal knob assembly system of claim 6; and
operatively associating the knob portion to a respective input end of said universal knob assembly system to control a rotation of a desired intrinsic knob stem.
